(19) United States
(12) Patent Application Publication
(10) Pub. No.: US 2022/0270441 A1
(43) Pub. Date: Aug. 25, 2022

(54) Method of playing wagering games

(71) Applicant: Raphael Mourad, Thornhill (CA)

(72) Inventor: Raphael Mourad, Thornhill (CA)

(21) Appl. No.: 16/873,443

(22) Filed: Apr. 14, 2020

(51) Int. Cl. G07F 17/32; A63F 1/00

(52) U.S. Cl. CPC G07F 17/3244; G07F 17/3293; G07F 17/3276; A63F 1/00; A63F 2001/001; A63F 2001/003

(57) ABSTRACT

A new method of playing wagering (casino type) games is disclosed. The invention is disclosing a new method of playing wagering games that provides players or participants in the game with a Winning Frequency equal or higher than the Loosing Frequency. Its application to the conventional most popular card games Baccarat and Blackjack presents two new games as described in the disclosure with a huge improvement over the current art.

### THE INVENTION

The present invention is the discovery of a new method of playing a wagering (casino type) game. The invention is disclosing a new method of playing wagering games that provides players or participants in the game with a Winning Frequency equal or higher than the Loosing Frequency. The disclosure is therefore of a new method of playing wagering games and not of a new wagering game in itself.

### CURRENT ART

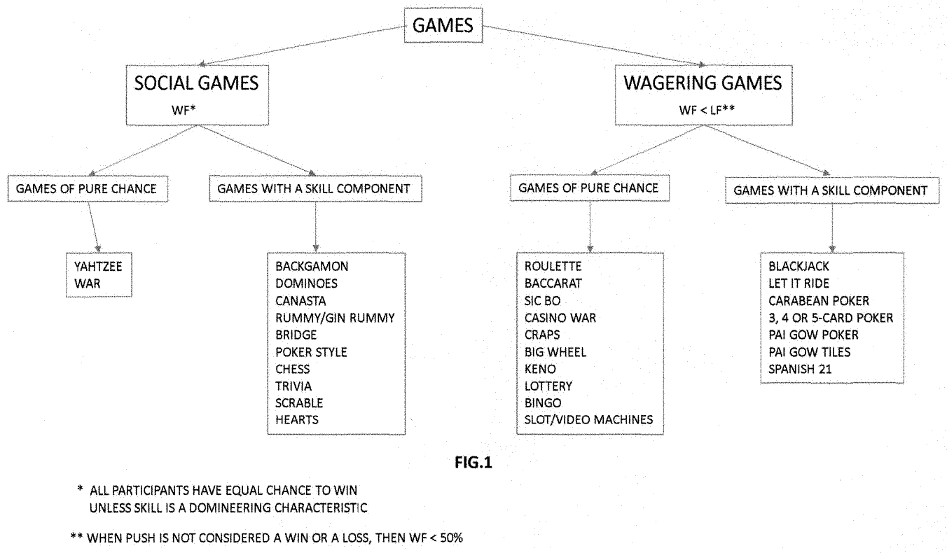

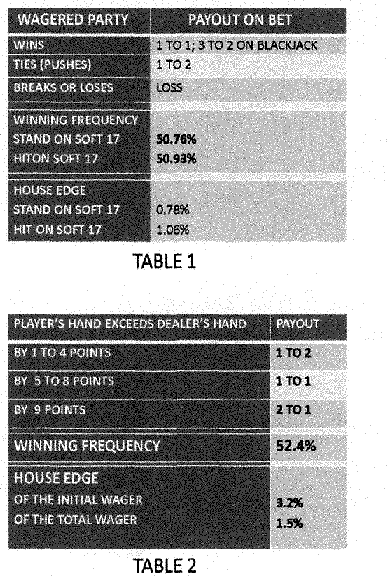

Competitive games are generally designed and divided into two main categories: social games (which are played in a casual setting) and wagering games (that are offered in casinos or gambling establishments). Both social and wagering games can be further divided into games of pure chance or games with a skill component. FIG.1 gives examples of games that fall into each of these four categories as given below:

Social game, pure chance: Yahtzee and War.

Social game, skill component: Backgammon, Dominoes, Canasta, Rummy, Gin Rummy, Bridge, Poker, Chess, Trivia, Scrable and Hearts.

Wagering game, pure chance: Roulette, Baccarat, Sic Bo, Casino War, Craps, Big Wheel, Keno, Lottery Bingo and slot/video Machines.

Wagering game, skill component: Blackjack, Let it Ride, Carabean Poker, 3, 4 or 5-Card Poker, Pai Gow Poker, Pai Gow Tiles and Spanish 21.

The main element of distinction between social and wagering games is the winning chance or the Winning Frequency (herein defined as WF) of a participant in the said game, i.e. the fraction of winning rounds out of a large number of rounds played. In parallel, Losing Frequency (herein defined as LF) is the fraction of losing rounds out of a large number of rounds played.

Social pure chance games are designed and conducted so that all participants have equal chance of winning; if two people are playing a social pure chance game (whereby one of the two individuals is declared a winner at the end of the round of play), each party has a WF of 50%. In social games with a skill component, a participant who has more skill than the others will have a higher WF.

In wagering pure chance games, however, where a player is playing against the House (casino or a gaming establishment), each player has a WF of less than 50%. This is because the number of winning outcomes is less or much less than half the total number of possible outcomes. Wagering pure chance games are methodically designed and conducted in a manner that leads to a player's WF of less than 50%. Some examples of these games and their respective WF's include:

Roulette: <47.4%

Baccarat: <49.3%

Sic Bo: <48.6%

Casino War: 46.3%

Craps (place bet): <45.5%

Big Six wheel: <44.4%

Slot/Video Machines: <40%

As an example, a player in Roulette who places a wager on the betting option with the highest WF (Black or Red) has the chance to win in 18 possibilities out of 38 possible outcomes leading to a WF of 18/38 or 47.4%. A wager placed on any other betting option will have a WF of less than or equal to 47.4%. Baccarat is another example of a pure chance wagering game that is designed and conducted with a WF of less than LF (49.3% vis 50.7% when push is not considered a win or a loss, or 44.6% vis 45.9% with a push frequency of 9.5%).

Wagering games with a skill component are also designed and conducted so that the WF, even of a skilled player (who uses the basic player strategy), is less than the LF. For example, in Blackjack, WF is 47% vis 53% when push is not considered a win or a loss or 43.0% vis 48.5%, with a push frequency of 8.5%. The WF of an unskilled player (who uses any other strategy) is even lower.

The present disclosure is the invention, design, and conduction of wagering games that provides players or participants with a Winning Frequency equal or higher than the Losing Frequency, or higher than 50% when Pushes are not counted or not relevant.

### DISCLOSURE AND EMBODIMENTS

The present disclosure is the discovery of a new method of playing a wagering (casino type) game. The invention is disclosing a new method of playing wagering games that provides players or participants in the game with a WF equal or higher than the LF. The disclosure is therefore of a new method of playing wagering games and not of a new wagering game in itself.

Two embodiments are disclosed when conventional cards are used in the wagering games. The two successful applications to conventional card type games, as described in the current disclosure, present huge improvements to the two most popular card games in the world; Baccarat and Blackjack. The applicant is aware that other successful applications of the invention are possible in the context of other wagering games, but has decided to emphasize only the enclosed two embodiments due to their huge success potential and improvement of the two main games offered in the gaming industry.

In a preferred embodiment, the invention is applied to Baccarat, a very ancient and popular game that is typically played with eight decks of 52 standard playing cards. It is a comparing card game played between two hands, the “player” and the “banker” using the Baccarat counting system. Each Baccarat round of play has three possible outcomes: “player” wins (player has the higher score), “banker” wins, and “tie”. After bets are made, two cards are dealt face up to each hand. Face cards and Tens are worth zero, aces counts as one, and all other cards are worth face value. The total of a hand is the sum of the values of the individual cards in the hand, modulo 10, meaning that the first digit is dropped if the total is greater than nine. A total of 8 or 9 on the first two cards is called a natural. If either hand has a natural, the round of play is over and wagers are resolved. If neither hand has a natural, a fixed set of rules is applied to determine if either hand receives a third and last card. Once the hands are complete, the hand with higher total wins. If the two hands have equal totals, it is a tie and bets are a push.

As mentioned above, the drawing rules of the third card are fixed, no place for strategic decision, as they are followed in exact manner by the House, (dealer}. These rules are not easy to remember and the average player will have some difficulty to understand and follow. As mentioned before, the “player” WF is less than the LF (49.3% vis 50.7% when push is not considered a win or a loss, or 44.6% vis 45.9% with a push frequency of 9.5%).

The fact that “Player” loses more often than “Player” wins in Baccarat is due to the rules governing the withdrawal of a third card to each party which are favoring the “Banker”. In order to have the WF equal to both parties, the same rules of withdrawing cards beyond the two cards initially dealt should be equally applied to both parties. Furthermore, to have the WF equal to or higher than 50% to both parties, we got to use a different scoring system than the Baccarat scoring system and change those “tie” events to “winning” events to both parties. These goals are practically and successfully being accomplished when the Blackjack scoring system is used instead of the Baccarat scoring system, when the Blackjack House rules of cards withdrawals are applied instead of the uneven third card withdrawal rules in Baccarat, and when the “tie” events become ‘winning” events instead of pushes.

The new proposed game is easy to understand and simple to play, challenging and more enjoyable. The evaluation of the new game shows that the “player” or “Banker” is always higher than 50%, (50.76% if hands hit on soft 17, and 50.93% if hands stand on soft 17).

Since the new game has been set and proven to have a Winning Frequency higher than the Loosing Frequency, a fair and simple payout schedule can then be established to give a slight advantage to the House. Table 1 provides an example of a payout schedule giving the House an edge of 0.78% or 1.06%. The new formed game is indeed a successful application of the invention and also solves all the hidden problems in Baccarat (challenging and not boring, easier rules for the withdrawal of additional cards, and elimination of the commission).

In another embodiment, the invention is applied to the most popular game in the world “Blackjack”, typically played with one to eight decks of 52 standard playing cards. It is a comparing card game played between a player and the House/dealer, using the Blackjack scoring system. In this method of playing BlackJack, after each player has placed a wager to play against the House/dealer, two cards are dealt face up to each player and two cards to the dealer, one face up and the other face down. Each of the cards 2 to 9 having equal value to the number of the corresponding card, an ace has a value of one or eleven, and each of the tens, jacks, queens and kings having a value of ten, a total count of any hand being the sum the value of the cards in the hand. Accordingly, the value of each of the hands with the two cards initially dealt to each player and to the house has a value between a minimum of 2 and maximum of 21. The player's objective in Blackjack is to beat the dealer by having a total higher than the dealer without exceeding 21. The game is conducted according to two strict rules as follow: the first main rule of the game is that a player's or a dealer hand total value must be equal or less than 21 in order to be alive, otherwise it is considered a “broken” or “busted” hand and out of play. Players and dealer may withdraw additional cards, beyond the initially two cards dealt to them. Players are the first to act, followed by the dealer. The player can take as many cards as he/she wants until the player is satisfied or busts. If the player busts, he/she automatically loses his/her wager. The second rule of the game is that the dealer must adheres to a fixed set of rules in withdrawing additional cards; dealer must withdraw additional cards, beyond the first two cards initially dealt to the dealer, if the dealer hand value is less than 17, and stand with a hand value between 17 and 21. If the dealer busts, all players remaining in the game (who did not bust) win and are paid by the House. If the dealer does not bust, the dealer's hand is compared with each of the remaining player's hands to resolve the wagers placed. As mentioned before, in Blackjack the player's WF is 47% with a LF of 53% when push is not considered a win or a loss, and 43.0% with a LF of 48.5%, with a push frequency of 8.5%.

The fact that a Blackjack player loses more often than wins is due to the following two factors; player may bust before the dealer even acts, and if the player does not bust, then dealer must withdraw cards in accordance to the house rules. In order to change things around, i.e. to have the player WF equal to or higher than the LF, these two factors have to be reversed by using a different scoring system than the Blackjack scoring system that prevents the player to bust at any time, and by preventing the house from withdrawing any additional cards beyond the two cards initially dealt to the House. These goals are achieved in this embodiment by using the Baccarat scoring system, as described before, instead of the Blackjack scoring system, and by preventing the dealer from withdrawing cards beyond the first two cards dealt to the dealer. The fact that a player of the new game wins more often than loses is due to the following reasons; player never busts, and player, and player only, can improve his or her two card hand.

The evaluation of the new game shows that the player WF who uses the optimum player strategy is significantly higher than the LF (52.4% vis 37.2%, with a push frequency of 10.4%). When the player uses a different strategy, then the WF slightly decreases but is always higher than the LF.

Since the new game has been set and proven to have a Winning Frequency higher than the Loosing Frequency, a fair and simple payout schedule can then be established to give a slight advantage to the House. Table 2 provides an example of a payout schedule giving the House an edge of 3.2% of the initial wager and 1.5% of the total wager. The analysis of the proposed new game shows also that card counting and deviation from its optimum strategy of the proposed new game have no impact on the outcome of the game. The new proposed game is indeed a successful application of the invention and also solves all the hidden problems in Blackjack (Busting, card counting, player frustration and deviation from basic strategy).

I claim;

1. A method of playing a casino type game that provides the player with a Winning Frequency equal or higher than the Losing Frequency.

2. The method of claim 1 whereas the game is a card game involving at least one player and a dealer conducting the game on behalf of the House, said game comprising the steps of:
Having each player make an initial wager on Party A and/or Party B;
Dealing randomly two cards to each Party from at least one deck of playing cards, each deck comprising four suites of cards, including spot cards with numbers from two to ten, jacks, queens, kings and aces, each of the spot cards from 2 to 10 having a value equal to the number of the corresponding spot card, each of the jacks, queens and kings having a value of ten, and each of the aces having a value of one or eleven, a total count of any hand being a sum of the value of the cards in the hand;
Dealing one or more additional cards to a party's hand that has a score of less than 17 until the said hand is alive with a score of 17 to 21 or has busted if its score is more than 21;
Collecting wagers associated with any busted hand;
Comparing the scores of Party A and Party B live hands and paying wagers associated with the only live hand or the high score hand or the two equal score hands according to a predetermined collection and payout schedule which gives a statistical advantage to the House.

3. The method of claim 1 whereas the game is a card game involving a dealer and at least one player, said game comprising the steps of:
Having each player make an initial wager against a gaming house conducting the card game;
Dealing two cards to each player and to the dealer from at least one deck of playing cards, one of the dealer's two cards is facing down, each deck comprising four suites of cards, including spot cards with numbers from ace to ten, jacks, queens and kings, each of the spot cards from 2 to 9 having a value equal to the number of the corresponding spot card, each ace having a value of one, and each of the tens, jacks, queens and kings having a value of zero, a total count of any hand being a sum of the value of the cards in the hand except that a sum of two digits has a total count equal to the last digit;
Allowing each player only, but not the dealer, options to draw additional cards or to split two cards with the same value, in an effort to improve the players' hands; and
Exposing the house facing down card, and comparing the total count of the dealer's two card hand with the total count of each player's hand after exercise of any of said options by each player, and collecting losing wagers and paying winning wagers according to a predetermined collection and payout schedule which gives a statistical advantage to the House.

4. An apparatus for playing a simulated casino type game that provides the player with a Winning Frequency equal or higher than the Losing Frequency.

5. The method of claim 4 whereas the game is a simulated card game comprising:
A display;
A computer processor in communication with said display, said processor having a data structure storing data capable of representing at least one deck of playing cards and data representing a predetermined payment schedule, each deck comprising four suites of cards, including spot cards with numbers from ace to ten, jacks, queens and kings, each of the spot cards from 2 to 10 having a value equal to the number of the corresponding spot card, ace has a value of 1 or 11, and each of the tens, jacks, queens and kings having a value of ten, a total count of any hand being a sum of the value of the cards in the hand;
Said processor having means for randomly selecting playing card data from said data structure; means for accepting wagers on Party A and/or Party B from at least one player in communication with said processor;
Said processor configured to, upon prompting of play, select and display first and second cards for two parties, Party A and Party B;
Said processor having means to display additional cards to each party that has a score of less than 17 until the said hand is alive with a score of 17 to 21 or has busted if its score is more than 21;
Said processor being operative to collect wagers associated with any busted hand;
Said processor being operative to compare the two parties' scores and pay wagers associated with the only live hand or the high score hand or the two equal score hands according to a predetermined collection and payout schedule which gives a statistical advantage to the House.

6. The method of claim 4 whereas the game is a simulated card game comprising:
A display;
A computer processor in communication with said display, said processor having a data structure storing data capable of representing a deck of playing cards and data representing a predetermined payment schedule, each deck comprising four suites of cards, including spot cards with numbers from ace to ten, jacks, queens and kings, each of the spot cards from ace to 9 having a value equal to the number of the corresponding spot card and each of the tens, jacks, queens and kings having a value of zero, a total count of any hand being a sum of the value of the cards in the hand except that a sum of two digits has a total count equal to the last digit;
Said processor having means for randomly selecting playing card data from said data structure; means for accepting wagers from at least one player in communication with said processor;
Said processor configured to, upon prompting of play, select and display first and second cards for each player and a two card dealer hand one of the two dealer's two cards is facing down;
Said processor has means for each player only, but not the dealer, to input commands to the processor representing options comprising, to draw additional cards in addition to said first and second cards, or to split two cards with the same value, in an effort to improve the players' hands; and
The processor being operative to expose the dealer's face down card and compare the total count of the dealer's two card hand with the total count of all the cards in each player's hand after exercise of any player draw options, and collecting losing wagers and paying winning wagers, according to a predetermined collection and payout schedule which provides a statistical advantage to the House.
